(19) United States
(12) Patent Application Publication
(10) Pub. No.: US 2012/0176440 A1
(43) Pub. Date: Jul. 12, 2012

(54) OILY INK AND METHOD OF INKJET PRINTING

(75) Inventors: Yoshifumi WATANABE, Ibaraki-ken (JP); Kazuyuki ANDO, Ibaraki-ken (JP)

(73) Assignee: RISO KAGAKU COPORATION, Tokyo (JP)

(21) Appl. No.: 13/347,005

(22) Filed: Jan. 10, 2012

(30) Foreign Application Priority Data
Jan. 12, 2011 (JP) P2011-003796

(51) Int. Cl. B41J 2/015; C09D 11/14; C09D 11/06

(52) U.S. Cl. 347/20; 106/31.89; 106/31.68; 106/31.88

(57) ABSTRACT

An oily ink, wherein the oily ink comprises a pigment, a pigment dispersant, and an organic solvent, said oily ink comprising:
0.1 to 10% by mass, relative to a mass of the oily ink, of a nonionic surfactant having a HLB of from 6 to 16, wherein the nonionic surfactant having a HLB of from 6 to 16 is at least one selected from the group consisting of fatty acid esters, ethers of fatty acid esters, and polyoxyalkylene ethers.

### CROSS REFERENCE TO RELATED APPLICATION

This Application is based upon and claims the benefit of priority from Japanese Patent Applications No. 2011-003796 filed on Jan. 12, 2011, the entire contents of which are incorporated by reference herein.

### FIELD OF THE INVENTION

The present invention relates to an oily ink and a method of inkjet printing, particularly to an oily ink comprising a substance forming reverse vesicles, and a method of inkjet printing using the oily ink. The vesicles formed in the oily ink fill pores of paper to prevent strike-through of the oily ink.

### BACKGROUND OF THE INVENTION

An oily ink, hereinafter may simply be referred to as “ink”, has advantages that it does not cause curling of printing paper, and that it allows a shorter period of drying time. However, it shows a problem of so-called “strike-through” of the ink caused by a pigment penetrate into paper together with a solvent, reducing density of printed images.

To solve this problem, it is proposed in the patent publication 1 to incorporate inorganic fine particles in an oily ink to fill pores of paper by the inorganic fine particles. However, in inkjet printing, such effect of filling pores of paper is limited because the fine particles should have such a particle size that they do not plug ink nozzle of an inkjet head.

Patent publication 1: Japanese Patent Application Laid-Open No. 2008-239790

### SUMMARY OF THE INVENTION

### Problems to be Solved by the Invention

Therefore, an object of the present invention is to provide an oily ink and a method of inkjet printing that can form dense images on plain paper without the aforesaid drawback of inorganic particle.

### Means to Solve the Problems

Thus, the present invention is an oily ink, wherein the oily ink comprises a pigment, a pigment dispersant, and an organic solvent, said oily ink comprising:

0.1 to 10% by mass, relative to a mass of the oily ink, of a nonionic surfactant having a HLB of from 6 to 16, wherein the nonionic surfactant having a HLB of from 6 to 16 is at least one selected from the group consisting of fatty acid esters, ethers of fatty acid esters, and polyoxyalkylene ethers.

Further, the present invention is a method of inkjet printing using the aforesaid oily ink, comprising the steps of:

(1) heating the oily ink at a temperature of from 40 to 70° C.; and

(2) ejecting the heated oily ink.

### Effects of the Invention

In the present ink, the nonionic surfactant having a HLB of from 6 to 16 forms in the ink reverse vesicles, that is, a bimolecular or multi molecular membrane structure with a hydrophilic portion of the surfactant molecules facing inward and a lipophilic portion thereof facing outward. A reverse-vesicle-forming substance has been incorporated in a composition such as an ink composition as described in the Japanese Patent Application Laid-Open No. 2010-104946, for instance. However, the ink composition is in the form of emulsion, and the reverse-vesicle-forming substance is used as an emulsifier. In contrast, the ink of the present invention is not in the form of emulsion. Further, the effect of filling pores of paper is completely different in quality from the emulsifying effect.

### DETAILED DESCRIPTION OF THE PREFERRED EMBODIMENTS

The ink of the present invention comprises at least one nonionic surfactant, which may be hereinafter referred to as reverse-vesicle-forming agent, having a HLB of from 6 to 16, which is selected from the group consisting of fatty acid esters, ethers of fatty acid esters, and polyoxyalkylene ethers. A nonionic surfactant having a HLB outside the aforesaid range hardly forms a reverse vesicle in an oily ink. Preferably, a nonionic surfactant having a HLB of from 7 to 12 is used.

Examples of the fatty acid ester include polyhydric alcohol esters of saturated or unsaturated fatty acid such as glycerin fatty acid esters, polyethylene glycol fatty acid esters, sorbitan fatty acid esters, and sucrose fatty acid esters. Examples of ethers of fatty acid esters include ethylene oxide adducts of the aforesaid fatty acid esters. Examples of polyoxyalkylene ether include polyoxyethylene alkyl ethers, polyoxyethylene alkyl phenyl ethers, polyoxyethylene alkenyl ethers, and polyoxypropylene alkyl ethers.

Among the aforesaid fatty acid esters, sucrose fatty acid esters are preferred. Examples of the sucrose fatty acid esters include sucrose esters of fatty acid having 12 to 22 carbon atoms such as those sold under the trade names of S-770 (sucrose stearate with 40% monoester, and 60% di-, tri-, and polyesters), S-970 (sucrose stearate with 50% monoester, and 50% di-, tri-, and polyesters), P-1570 (sucrose palmitate with 70% monoester), M-1695 (sucrose myristate with 80% monoester), andL-1695 (sucrose laurate with 80% monoester), all available from Mitsubishi-Kagaku Foods Co.

The polyoxyethylene alkyl ether represented by the following formula (1) is also preferred.

R—O—(C₂H₄O)ₙ—H (1)

In the above formula, R is an alkyl or alkenyl group having 10 to 20, preferably from 12 to 18, carbon atoms, n is an integer of from 2 to 10, preferably from 3 to 7. Examples of such polyoxyethylene alkyl ether include polyoxyethylene capryl ether, polyoxyethylene lauryl ether, polyoxyethylene palmityl ether, polyoxyethylene stearyl ether, and polyoxyethylene oleyl ether.

The reverse-vesicle-forming agent is contained in the ink in an amount, relative to a mass of the oily ink, of from 0.1 to 10% by mass, preferably from 0.5 to 7.0% by mass, and more preferably from 1 to 5% by mass. If it were contained in an amount less than the aforesaid lower limit, a satisfactory effect of preventing strike-through would not be achieved. If it were contained in an amount exceeding the above upper limit, a viscosity of an ink could be increased.

Preferably, the present ink comprises a nonionic surfactant, which may be hereinafter referred to as a stabilizer, having a HLB of from 1 to 5 to stabilize the reverse vesicles. Examples of the nonionic surfactant include the nonionic surfactants having HLB of from 1 to 5, preferably from 2 to 5, of the similar ester or ether type listed above for the reverse-vesicle-forming agent. A nonionic surfactant having a HLB outside the above range would not be able to stabilize reverse vesicles.

Preferred stabilizers include sorbitan fatty acid esters and/or polyethylene glycol fatty acid esters. Examples of the sorbitan fatty acid ester include sorbitol esters of fatty acid having 18 to 30 carbon atoms such as sorbitan monostearate, sorbitan distearate, sorbitan tristearate, sorbitan monooleate, sorbitan trioleate, and sorbitan sesquioleate. Examples of the polyethylene glycol fatty acid esters include esters of fatty acid having 12 to 22 carbon atoms with polyethylene glycol ethoxylated with 1 to 4 moles of ethylene oxide (EO) such as polyethylene glycol laurate, polyethylene glycol monooleate, polyethylene glycol monostearate, polyethylene glycol distearate, and polyethylene glycol diisostearate.

The stabilizer is contained in the ink in an amount, relative to the mass of the oily ink, of from 0.1 to 10% by mass, preferably from 0.5 to 7.0% by mass, and more preferably from 1.0 to 5.0% by mass. If it were contained in an amount less than the aforesaid lower limit or more than the aforesaid upper limit, stability of reverse vesicles would not be good enough to achieve satisfactory prevention of strike-through.

In the present ink, any pigment can be used. Examples of pigments include organic pigments, for example, azo-based pigments, phthalocyanine-based pigments, dye-based pigments, condensed polycyclic pigments, nitro-based pigments and nitroso-based pigments such as brilliant carmine 6B, lake red C, Watchung red, disazo yellow, Hansa yellow, phthalocyanine blue, phthalocyanine green, alkali blue, and aniline black; inorganic pigments, for example, oxides or sulfides of metals such as cobalt, iron, chrome, copper, zinc, lead, titanium, vanadium, manganese and nickel, yellow ocher, ultramarine, and iron blue pigments; and carbon black such as furnace carbon black, lamp black, acetylene black, or channel black. Combination of two or more of these pigments can be used.

From the viewpoints of dispersibility and storage stability, the average particle size of the pigment is preferably not larger than 300 nm, more preferably not larger than 150 nm, and most preferably not larger than 100 nm. The average particle size can be measured using a dynamic light-scattering particle size distribution measurement apparatus.

The pigment is contained in the ink usually in an amount of from 0.01 to 20% by mass, preferably of from 1 to 15% by mass, and most preferably from 5 to 10% by mass from the viewpoints of printing images density and viscosity of the ink.

As the pigment dispersant, various kinds of dispersants can be used. Examples of the pigment dispersant include hydroxyl group-containing carboxylic acid esters, salts of long-chain polyaminoamides and high-molecular weight acid esters, salts of high-molecular weight polycarboxylic acids, salts of long-chain polyaminoamides and polar acid esters, high-molecular weight unsaturated acid esters, modified polyurethanes, modified polyacrylates, polyether ester anionic surfactants, naphthalenesulfonic acid-formalin condensate salts, polyoxyethylene alkyl phosphate esters, polyoxyethylene nonylphenyl ethers, polyester polyamines, and stearyl amine acetate.

Among these dispersants, polymer dispersants are preferred. Examples of the polymer dispersants include commercially available polymer dispersants such as Solsperse 5000 (phthalocyanine ammonium salt type), 11200 (polyamide type), 13940 (polyester amine type), 17000, 18000 (aliphatic amine type), 22000, 24000, and 28000, all available from Lubrizol Japan Ltd.; Efka 400, 401, 402, 403, 450, 451, 453 (modified polyacrylate), 46, 47, 48, 49, 4010, and 4055 (modified polyurethane), all available from Efka CHEMICALS; Demor P, EP, Poiz 520, 521, 530, and Homogenol L-18 (high molecular weight polycarboxylic acid surfactant), all available from KAO CORPORATION; Disparlon KS-860, KS-873N4 (amine salt of high molecular weight polyester), both available from Kusumoto Chemicals Ltd.; Discol 202, 206, OA-202, and OA-600 (multi-chain high molecular weight nonionic surfactant), all available from DAI-ICHI KOGYO SEIYAKU CO., LTD; and ANTARON V216 (vinyl-pyrrolidone/hexadecene copolymer) available from ISP Japan Co. Ltd., among which polyamide type and vinyl-pyrrolidone/hexadecene copolymer are preferred.

The content of the pigment dispersant is an amount enough to achieve a thorough dispersion of the pigment in the ink. Usually, the content of the pigment dispersant as solid is such that a mass ratio of the pigment dispersant to the pigment ranges from about 0.1 to 2, preferably from about 0.3 to 1.0.

As the organic solvent, a non-polar solvent, a polar solvent or a mixture of these solvents can be used to prepare a solvent system in which the reverse-vesicle-forming agent forms stable reverse vesicles.

Examples of the non-polar solvents include aliphatic hydrocarbon solvents, alicyclic hydrocarbon solvents and aromatic hydrocarbon solvent. Examples of the aliphatic hydrocarbon solvents and alicyclic hydrocarbon solvents include paraffinic solvents, isoparaffinic solvents, and naphthenic solvents, for example, those sold under the following trade names of Teclean N-16, Teclean N-20, Teclean N-22, Nisseki Naphtesol L, Nisseki Naphtesol M, Nisseki Naphtesol H, No. 0 Solvent L, No. 0 Solvent M, No. 0 Solvent H, Nisseki Isosol 300, Nisseki Isosol 400, AF-4, AF-5, AF-6 and AF-7, all manufactured by JX Nippon Oil & Gas Exploration Co., and Isopar G, Isopar H, Isopar L, Isopar M, Exxsol D40, Exxsol D80, Exxsol D100, Exxsol D130 and Exxsol D140, all manufactured by Exxon Mobil Corporation.

Examples of the aromatic hydrocarbon solvents include Nisseki Cleansol G (alkylbenzene) manufactured by JX Nippon Oil & Gas Exploration Co., and Solvesso 200 manufactured by Exxon Mobil Corporation.

Among these solvents, naphthenic solvents such as those sold under the trade names of AF-4, AF-5, AF-6 and AF-7 are preferably used.

Examples of polar solvents include ester solvents, alcoholic solvents, higher fatty acid solvent, and ether solvents. Examples of the ester solvent include methyl laurate, isopropyl laurate, hexyl laurate, isopropyl myristate, isopropyl palmitate, isooctyl palmitate, methyl oleate, ethyl oleate, isopropyl oleate, butyl oleate, methyl linoleate, isobutyl linoleate, ethyl linoleate, isopropyl isostearate, methyl soybean oil, isobutyl soybean oil, methyl tallate, isobutyl tallate, diisopropyl adipate, diisopropyl sebacate, 7 diethyl sebacate, propylene glycol monocaprate, trimethylolpropane tri-2-ethylhexanoate and glyceryl tri-2-ethylhexanoate.

Examples of the alcohol solvent include isomyristyl alcohol, isopalmityl alcohol, isostearyl alcohol and oleyl alcohol.

Examples of the higher fatty acid solvents include isononanoic acid, isomyristic acid, hexadecanoic acid, isopalmitic acid, oleic acid and isostearic acid.

Examples of the ether solvents include diethylene glycol monobutyl ether, ethylene glycol monobutyl ether, propylene glycol monobutyl ether and propylene glycol dibutyl ether.

A mixture of two or more of these solvents can be used. Among these solvents, ester solvents, alcoholic solvents, and mixtures thereof are preferred.

Preferably, non-polar solvents, particularly naphthenic solvents, are used. When a polar solvent is used, its content in the ink, though it varies depending on the reverse-vesicle-forming agent and the stabilizer, is such that a mass ratio of the non-polar solvent/the polar solvent ranges preferably from 1/0.1 to 1/0.8, more preferably from 1/0.2 to 1/0.5.

In addition to the aforesaid components, the present ink can comprise a conventionally used additive in such an amount that it does not adversely affect the ink. Examples of the additive include antioxidants such as dibutylhydroxytoluene, propyl gallate, tocopherol, butylhydroxyanisole, and nordihydroguaiaretic acid.

The oily ink of the present invention can be prepared by preparing separately a pigment dispersion and a dispersion of reverse vesicles by dispersing a pigment in a part of the organic solvent with a means of mixing such as a mill, and by mixing a reverse-vesicle-forming agent, and optionally a stabilizer, with a part of the organic solvent, respectively, and then mixing the both dispersions and the rest of the organic solvent followed by filtering the mixture with a filter means such as a membrane filter to remove solid substance, if any. The filtering step may be performed after heating the mixture at a temperature of from 40 to 70° C. for 1 to 2 minutes. The dispersion of reverse vesicles can be prepared by merely mixing a reverse-vesicle-forming agent, and optionally a stabilizer, with a part of the organic solvent. The mixing can be performed by a known mixing means such as a mixer and ultrasonic apparatus. Preferably, the mixture is heated at a temperature of from 40 to 70° C. for 1 to 2 minutes while mixing, and then cooled to room temperature, whereby stable reverse vesicles are formed. The formation of the reverse vesicles can be confirmed by a polarization optical microscope, a differential interference microscope, or a freeze-fracture electric microscope observation.

The ink thus obtained is suitably used for inkjet printing. Thus, another aspect of the present invention is a method of inkjet printing by using the ink of the present invention. The method comprises the steps of (1) heating the oily ink at a temperature of from 40 to 70° C., and (2) ejecting the heated oily ink. It should be noted the present oily ink can be ejected without heating it. However, heating makes the ejection more stable for the reason that a lower viscosity and smaller size of reverse vesicle caused by the heating facilitate the vesicles to pass through a nozzle of an inkjet head. The heated ink is cooled during flying, landing on paper, and penetrating into paper to form larger reverse vesicles, which then plug pores of paper to prevent the pigment from penetrating into paper, resulting in improved density of printed image and reduced strike-through.

The ink can be used in any inkjet recording apparatus such as a piezo system, an electrostatic system or a thermal system, among which piezo system is preferred.

### EXAMPLES

The present invention will be explained with reference to the examples described below, although the present invention is in no way limited by these examples. In the following, “part” means “part by mass” unless otherwise specified.

### Examples 1-8

Each oily ink was prepared according to the formulation shown in Table 2. A dispersion of a pigment was prepared by placing, in a glass container, 8 parts of a pigment, 8 parts of a pigment dispersant as it is, 16 parts of an organic solvent, and zirconia beads (diameter: 0.5 mm), and then shaking the container using a rocking mill (Model RM05S, ex Seiwa Technical Lab Co., Ltd.) at 65 Hz for 120 minutes.

A dispersion of reverse vesicles was prepared by mixing 18 parts of an organic solvent and a reverse-vesicle-forming agent in an amount as shown in Table 2, and a stabilizer in Examples 2 to 6. The mixture was heated at a temperature of 60° C. for 1 to 2 minutes, treated with a ultrasonic disperser, and then cooled to room temperature. Subsequently, 32 parts of the pigment dispersion, 20 parts of the reverse vesicle dispersion, and 48 parts of an organic solvent were mixed and then filtered using a 3.0-μm pore size membrane filter.

Details of the components shown in Table 2 are as follows:

Black pigment: MA7, ex Mitsubishi Chemical Co.

Cyan pigment: copper phthalocyanine, ex DIC Co.

Pigment dispersant: Solsperse S13940, 40% solid content, ex Lubrizol Co.

Naphthenic solvent: AF-4, ex JX Nippon Oil & Gas Exploration Co.

Fatty acid ester: methyl oleate

Sucrose fatty acid esters:
S-770(sucrose stearate, ex Mitsubishi-Kagaku Foods Co.)
S-970(sucrose stearate, ex Mitsubishi-Kagaku Foods Co.)

Polyoxyethylene alkyl ether:
BL-4.2 (polyoxyethylene(4.2)lauryl ether, ex Nikko Chemicals Co., Ltd) BO-7 (polyoxyethylene(7) oleyl ether, ex Nikko Chemicals Co., Ltd)

Sorbitan fatty acid esters:
SO-15(sorbitan sesquioleate, ex Nikko Chemicals Co., Ltd)
SO-30(sorbitan trioleate, ex Nikko Chemicals Co., Ltd)

Polyethylene glycol fatty acid ester:
MYO-2 (polyethylene glycol monooleate)

### Comparative Example 1

An oily ink was prepared in the similar manner as examples, except that the dispersion of reverse vesicles was not incorporated and 68 parts of the naphthenic solvent was incorporated.

### Comparative Example 2

An oily ink was prepared in the similar manner as examples, except that the dispersion of reverse vesicles was not incorporated, and 2 parts of sorbitan fatty acid ester and 66 parts of the naphthenic solvent were incorporated.

<Method of Evaluation of Printed Images>

A piezo-type inkjet head manufactured by Toshiba TEC Co. was filled with the prepared ink. After heating the head at a temperature of 40° C., a solid image was printed on plain paper (Riso lightweight paper, ex Riso Kagaku Co.) with 42 pl per dot and with 300 dpi×300 dpi resolution. A density of each image was measured by using a Macbeth reflective densitometer (RD920, ex GretagMacbeth Corporation), and was rated according to the criteria shown in Table 1. The results are as shown in Table 2 where the term “Ex.” stands for “Example” and “Comp. Ex.” stands for “Comparative Example.”

TABLE 1

| Rating | Image density (OD value) | Strike-through (OD value) |
|---|---|---|
| A | above 1.15 | below 0.20 |
| B | above 1.10 and 1.15 or lower | 0.20 or higher and below 0.25 |
| C | above 1.05 and 1.10 or lower | 0.25 or higher and below 0.30 |
| D | 1.05 or lower | 0.30 or higher |

TABLE 2

| | | | | | | | | | | Comp. | Comp. |
|---|---|---|---|---|---|---|---|---|---|---|---|
| | | Ex. 1 | Ex. 2 | Ex. 3 | Ex. 4 | Ex. 5 | Ex. 6 | Ex. 7 | Ex. 8 | Ex. 1 | Ex. 2 |
| Pigment | Black | 8 | 8 | 8 | 8 | | 8 | 8 | 8 | 8 | 8 |
| | Cyan | | | | | 8 | | | | | |
| Pigment dispersant | | 8 | 8 | 8 | 8 | 8 | 8 | 8 | 8 | 8 | 8 |
| Organic solvent | Naphthene | 82 | 54 | 78 | 83 | 80 | 80 | 82 | 82 | 84 | 82 |
| | Fatty acid ester | | 26 | | | | | | | | |
| Sucrose fatty | S770(HLB 7) | | | 4 | 0.5 | | | | | | |
| acid ester | S970(HLB 9) | 2 | 2 | | | 2 | 2 | | | | |
| Polyoxyalkylene | BL-4.2 | | | | | | | 2 | | | |
| ether | (HLB 11.5) | | | | | | | | | | |
| | BO-7 | | | | | | | | 2 | | |
| | (HLB 10.5) | | | | | | | | | | |
| Sorbitan fatty | SO-15 | | 2 | | | 2 | | | | | 2 |
| acid ester | (HLB 3.7) | | | | | | | | | | |
| | SO-30 | | | 2 | 0.5 | | | | | | |
| | (HLB 1.7) | | | | | | | | | | |
| Polyethylene glycol | MYO-2 | | | | | | 2 | | | | |
| fatty acid ester | (HLB 4.5) | | | | | | | | | | |

| | | | | | | | | | | |
|---|---|---|---|---|---|---|---|---|---|---|
| Total | 100 | 100 | 100 | 100 | 100 | 100 | 100 | 100 | 100 | 100 |
| Printed image density | A | A | A | B | A | A | B | A | D | D |
| Strike-through | A | A | A | B | A | A | B | A | D | D |

As shown in Table 2, the oily ink comprising reverse vesicles of the present invention formed dense images. On the other hand, the oily ink devoid of reverse vesicles of the comparative examples showed considerable strike-through.

### INDUSTRIAL APPLICABILITY

By inkjet printing with the oily ink according to the present invention, dense printed images are formed.

It should be noted that, besides those already mentioned above, various modifications and variations can be made in the aforementioned embodiments without departing from the novel and advantageous features of the present invention. Accordingly, it is intended that all such modifications and variations are included within the scope of the appended claims.

1. An oily ink, wherein the oily ink comprises a pigment, a pigment dispersant, and an organic solvent, said oily ink comprising:
0.1 to 10% by mass, relative to a mass of the oily ink, of a nonionic surfactant having a HLB of from 6 to 16, wherein the nonionic surfactant having a HLB of from 6 to 16 is at least one selected from the group consisting of fatty acid esters, ethers of fatty acid esters, and polyoxyalkylene ethers.

2. The oily ink according to claim 1, wherein the nonionic surfactant having a HLB of from 6 to 16 is a sucrose fatty acid ester.

3. The oily ink according to claim 1, wherein the nonionic surfactant having a HLB of from 6 to 16 is a polyoxyalkylene ether represented by the following formula (1):
R—O—(C₂H₄O)ₙ—H (1)
wherein R is an alkyl or alkenyl group having 10 to 20 carbon atoms, and n is an integer of from 2 to 10.

4. The oily ink according to claim 1, wherein the oily ink further comprises a nonionic surfactant having a HLB of from 1 to 5, said nonionic surfactant having a HLB of from 1 to 5 being at least one selected from the group consisting of fatty acid esters, ethers of fatty acid esters, and polyoxyalkylene ethers.

5. The oily ink according to claim 4, wherein the nonionic surfactant having a HLB of from 1 to 5 is a sorbitan fatty acid ester.

6. The oily ink according to claim 4, wherein the nonionic surfactant having a HLB of from 1 to 5 is a polyethylene glycol fatty acid ester.

7. The oily ink according to claim 1, wherein the organic solvent is a naphthenic solvent.

8. A method of inkjet printing using the oily ink according to claim 1, comprising the steps of:
(1) heating the oily ink at a temperature of from 40 to 70° C.; and
(2) ejecting the heated oily ink.
